(19) United States
(12) Patent Application Publication
(10) Pub. No.: US 2010/0050418 A1
(43) Pub. Date: Mar. 4, 2010

(54) BEARING PIN FOR LOCKING PIECES, IN PARTICULAR, A MOTOR VEHICLE DOOR LOCK

(75) Inventor: Dirk Hanisch, Koeln (DE)

Correspondence Address: Konomi Takeshita, Eight Penn Center, Suite 1300,, 1628 John F. Kennedy Blvd., Philadelphia, PA, 19103, US

(73) Assignee: KIEKERT AKTIENGESELLSCHAFT, Heiligenhaus (DE)

(21) Appl. No.: 12/616,722

(22) Filed: Nov. 11, 2009

Related U.S. Application Data
(62) Division of application No. 10/585,900, filed on May 22, 2007, now abandoned.

(30) Foreign Application Priority Data
Jan. 13, 2004 (DE) 10 2004 001 988.6

(51) Int. Cl. B23P 17/00

(52) U.S. Cl. 29/527.2

(57) ABSTRACT

A bearing pin (1) for locking pieces (2, 21, 22), in particular a motor vehicle door lock (3), in which the locking pieces (2, 21, 22) are at least partially rotationally mounted on the bearing pin (1) forming a bearing axis (L), comprising a carrier plate (4) which is made of a shape-retaining material, in particular metal, and which supports at least one locking piece (2, 21, 22), and from which a clip-shaped form (41) is formed in essentially the axial direction of the bearing axis (L) with the bearing pin (1) being formed by means of plastic extrusion coating (5) about the clip-shaped form (41).

### CROSS REFERENCE TO RELATED APPLICATIONS

This application claims priority under 35 U.S.C. 119 and 35 U.S.C. 365 based upon German Patent Application No. 10 2004 001 988.6, filed on Jan. 13, 2004. The entire disclosure of the aforesaid application is incorporated herein by reference.

### FIELD OF THE INVENTION

The invention relates to a bearing pin for locking pieces, in particular a motor vehicle door lock. The locking pieces are at least partially rotationally mounted on the bearing pin, forming a bearing axis. The invention also relates to a motor vehicle door lock comprising locking pieces mounted on a carrier plate on such a bearing pin.

### BACKGROUND OF THE INVENTION

Motor vehicle door locks that are usually used are supplied as separately installable parts, which are then installed by the vehicle manufacturer. The motor vehicle door lock contains in most cases moveable parts that should ensure safe locking of the vehicle door. In most cases, catches are used on the vehicle door side interacting with pins or blocks to lock the motor vehicle door.

The catches have to absorb considerable forces, as break-ins as well as an unwanted opening of the door, in case of an accident, must be prevented. The catches and the parts in the motor vehicle door lock on which the catches are mounted must therefore be mounted securely in the motor vehicle door lock.

The large number of individual parts that have to be installed separately constitute an expensive part of the production of standard motor vehicle door locks. The individual parts and the assembled unit have to withstand high mechanical requirements with regard to stability under load.

In modern vehicles it also has become more and more important that moved parts, such as motor vehicle door locks, work as quietly as possible. Conventional motor vehicle door locks therefore require additionally installed means or costly low-noise fixings. All the above measures and stipulations create additional costs due to the large number of different parts and the associated manufacturing steps.

### SUMMARY OF THE INVENTION

The invention has the task of reducing the aforementioned disadvantages and of providing an improved bearing for locking pieces as well as improved motor vehicle door locks, improving in particular the overall process sequence of production with regard to economic efficiency and quality.

The task is solved by a bearing pin for locking pieces according to claim 1 and a motor vehicle door lock with locking pieces mounted on a carrier plate according to claim 12.

According to the invention, a carrier plate, supporting at least one locking piece, is made of a shape-retaining material, in particular metal, from which a clip-shaped form is formed in essentially the axial direction of the bearing axis, with the bearing clip being formed by means of plastic extrusion coating about the clip-shaped form.

The invention suggests producing the support, which normally is provided by a solid metal axis, requiring separate installation, from a plastic extrusion coating part, formed from the carrier plate. The plastic extrusion coating of the bearing pin alone considerably reduces the noise of the catch in its bearing. The required high mechanical stability is provided by the clip-shaped form formed from the carrier plate.

The use of plastic also means a reduction in weight, which in turn reduces costs. Apart from providing considerable sound proofing, plastic also offers excellent properties with regard to temperature resistance, stability and distortion-resistance.

The plastics used may, for instance, be technical plastics and/or fiberglass or carbon-fiber reinforced plastic or elastomers.

The bearing axis is preferably produced by coating, using the so-called Outsert method. During this process, the plastic material is sprayed directly around the parts to be enclosed and edges, openings or projections on the metal carrier serving as an anchor or projection for the plastic. Assembly of the extruded parts is therefore not required. As a result, numerous process steps and material for the parts otherwise required for assembly are saved and costly logistics and storekeeping of parts that would otherwise have to be manufactured and supplied individually is also no longer required.

The Outsert method allows the production of very precise shapes with very low tolerances. As also no installation is required, any potential tolerances of the geometries associated therewith, are also avoided.

In a preferred embodiment of the invention the clip-shaped form has been punched out of the carrier plate and moved upright.

Preferably, the coating of the clip-shaped form forms a cylindrical bearing pin.

Also preferably the coating forms a bearing pin with a smaller internal and a larger external diameter with the larger diameter being provided in the main direction of the force transfer from the locking piece onto the bearing pin.

As a result of the thus chosen larger diameter, a wider clip-shaped form can be chosen, further increasing the divertible forces.

Consequently, a mainly dovetail-shaped bearing seat opening is provided in the locking piece, corresponding to the bearing pin, said opening having a corresponding smaller internal diameter and a larger external diameter. A further advantage of the cooperation of the thus designed bearing pin and bearing seat opening is that a definitive stop for the locking piece is created.

In an advantageous embodiment of the invention, the end of the bearing pin is seated in a recess in the lock housing enclosing the locking pieces at least partially.

Preferably, the locking pieces are a catch and/or a pawl of a motor vehicle door lock.

According to another aspect of the invention, a motor vehicle door lock with locking pieces on the carrier plate is suggested, in which at least one of the locking pieces is seated on a bearing pin according to claims 1 to 11.

In a preferred embodiment of the invention the carrier plate and/or the lock housing, covering at least partially the locking pieces on the carrier plate, contain guiding grooves and/or guiding elevations and/or stops for the locking pieces and/or other moved parts of the motor vehicle door lock consisting of an applied plastic coating or application.

Advantageously, the locking pieces partly contain a plastic extrusion coating, said plastic extrusion coating being applied, in particular, using the Outsert method.

In a particular advantageous further development of the invention, the external edges and/or edges of openings or punched-out sections of the carrier plate contain a plastic extrusion coating covering the edges at least partially, said plastic extrusion coating having, in particular, being applied using the Outsert method. As a result, potential injuries can be prevented and the usually required labor-intensive deburring is no longer necessary in most cases. The extrusion coating also protects the edges against corrosion as open punched or cut out areas are sealed and no longer in contact with air. As a result of the extrusion coating also thicker material can be used, whose edges do not contain an earlier applied protective layer, e.g. zinc layer because of the processing—e.g. punching. The extrusion coating also allows a better design in the visible area of the door lock, as any type of surface and forms can be achieved.

In order to reduce noise or friction, a further advantageous embodiment of the invention provides that at least partially between the locking pieces and the carrier plate and/or the frame box and/or the lock housing, a layer of extrusion coating is applied, in particular by the Outsert method. Such an extrusion coating applied from the outside can, apart from reducing the noise, also achieve an improved design of the entire motor vehicle door lock.

An embodiment characterized by an efficient production provides that the plastic extrusion coatings on the bearing plate are produced in a single production step, using the Outsert method.

Advantageously, the bearing plate is formed by a frame box of a motor vehicle door lock. If the Outsert method is used, also the lock housing enclosing the locking pieces on the bearing plate can be produced in one piece.

Other advantages, peculiarities and useful further developments of the invention are shown in the further subclaims or their subcombinations.

### BRIEF DESCRIPTION OF THE DRAWINGS

Below, the invention is explained in more detail with reference to drawings. The individual diagrammatic views are as follows:

FIG. 1 shows a top view from the front onto a carrier plate, containing bearing pins of the invention for accommodating locking pieces,

FIG. 2 shows a top view onto the carrier plate of FIG. 1, before application of the plastic extrusion coating around the punched-out clip for forming the bearing pins,

FIG. 3 shows a top view from the rear onto the carrier plate of FIG. 2,

FIG. 4 shows a top view from the front onto the carrier plate of FIG. 1, after the locking pieces have been placed onto the bearing pins,

FIG. 5 shows a top view from the rear onto the motor vehicle door lock of the invention, comprising a carrier plate shown in FIG. 4 with inserted locking pieces and positioned lock housing,

FIG. 6 shows a top view from the front onto the motor vehicle door lock of FIG. 5,

FIG. 7 shows a top view onto the lock housing of the motor vehicle door lock containing locking pieces corresponding to their position around the bearing pins, corresponding to FIG. 5,

FIG. 8 shows a top view from the front onto a carrier plate in which bearing pins are formed for accommodating locking pieces, in which one of the bearing pins is designed according to a type of the invention and

FIG. 9 shows an enlarged top view onto the bearing pin with a smaller internal diameter and a larger external diameter of FIG. 8.

### DETAILED DESCRIPTION OF THE INVENTION

The same reference figures in the drawings refer to the same elements or elements that function in the same way.

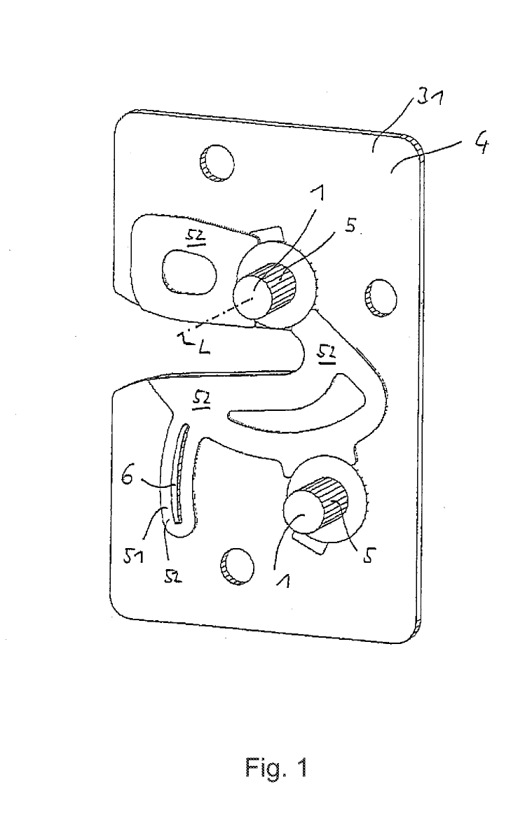

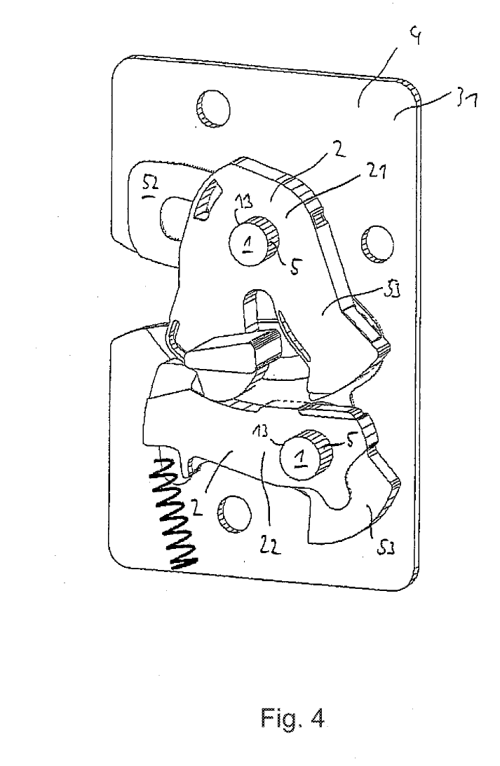

FIG. 1 is a schematic representation of a top view from the front onto a metal bearing plate 4, in the example a frame box 31 of a motor vehicle door lock containing bearing pins 1 of the invention for accommodating locking pieces. The bearing pins 1 have been formed by a plastic extrusion coating 5, produced using the Outsert method. Also a layer of plastic extrusion coating 52 was applied onto the surface of the carrier plate 4, serving partly as gliding aid and sound insulation between the locking pieces (see for instance FIG. 4) and the bearing plate. Also a guiding elevation 6 is formed by an applied plastic extrusion coating 51 on the surface of the carrier plate 4. This serves as a guide for the pawl, which is arranged above it at a later stage.

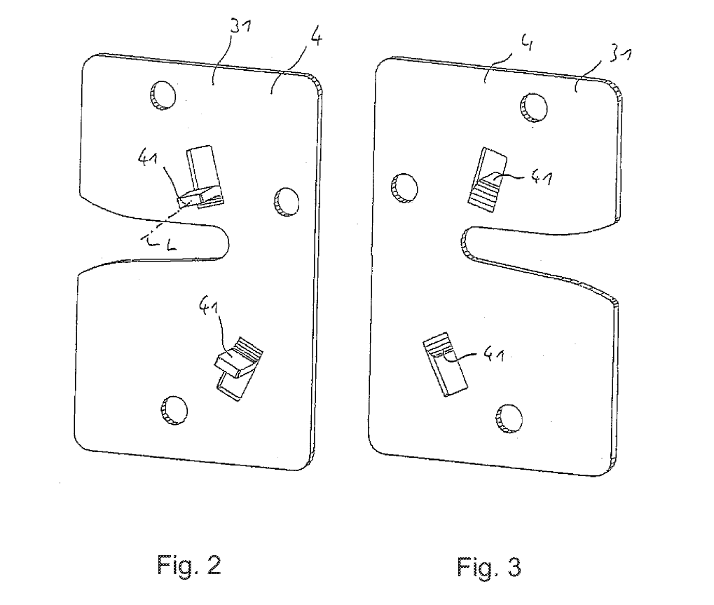

In the bearing pins, clip-shaped forms from the carrier plate are extrusion coated, as shown in more detail in FIG. 2 and FIG. 3.

FIG. 2 and FIG. 3. show a top view from the front and rear onto the carrier plate of FIG. 1, before application of the plastic extrusion coating around the punched-out clips 41 for forming the bearing pins.

The clip-shaped forms 41 are punched out of the carrier plate 4 in a single process step and are mainly righted up in axial direction of the bearing axis L.

The bearing pins 1 are then formed by plastic extrusion coating 5 around the clip-shaped form 41 in a joint process step, using the Outsert method.

FIG. 4 shows the carrier plate 4 with locking pieces 2 placed on the bearing pins 1.

The catch 21 and the pawl 22 are simply placed onto the ends 13 of the bearing pins 1 and pushed down against the carrier plate.

In order to achieve further noise reduction, the catch 21 and the pawl 22 are also partly coated with a plastic extrusion coating 53.

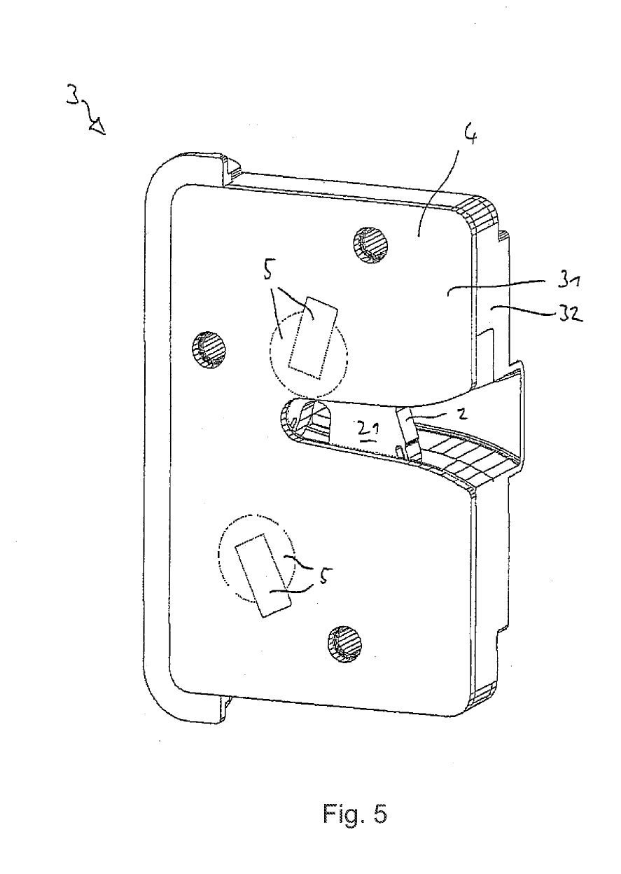

FIG. 5 shows a top view from the rear onto a fully installed motor vehicle door lock 3 of the invention as shown in FIG. 3. The frame box 31 (carrier plate 4) with the locking pieces 2 supported thereby is enclosed by the lock housing 32.

In this view, the plastic extrusion coating 5 of the bearing pins 1 can be seen from below.

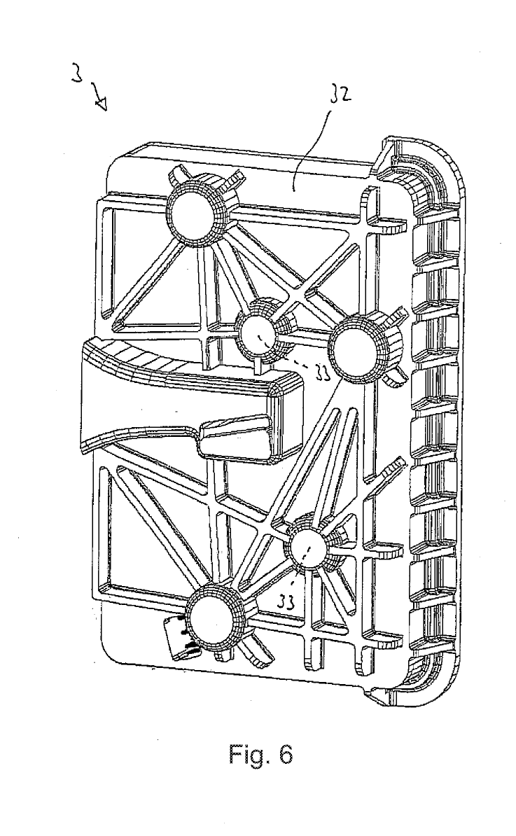

FIG. 6 shows a top view from the front onto the motor vehicle door lock 3 of FIG. 5. This view shows the forms for the recesses 33 in the lock housing 32, accommodating the ends 13 (see FIG. 4) of the bearing pins 1.

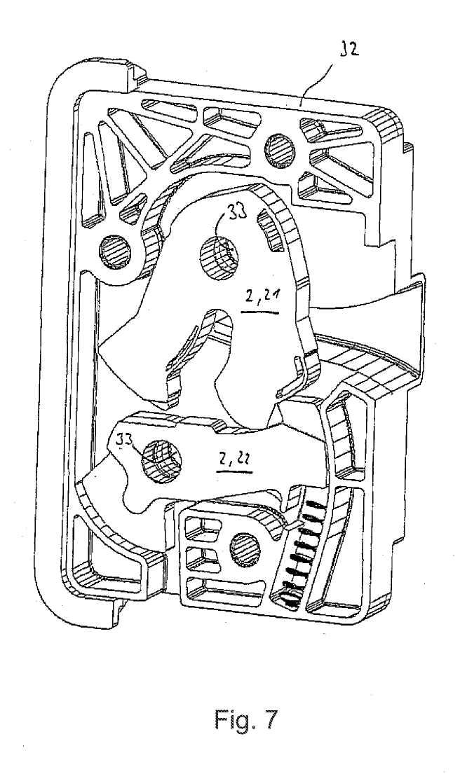

FIG. 7 explains the cooperation of the recesses 33 with the bearing pins 1 in a top view onto the lock housing 32 of the motor vehicle door lock 3 including the contained locking pieces 2, 21, 22 that are shown according to their position around the bearing pins 1.

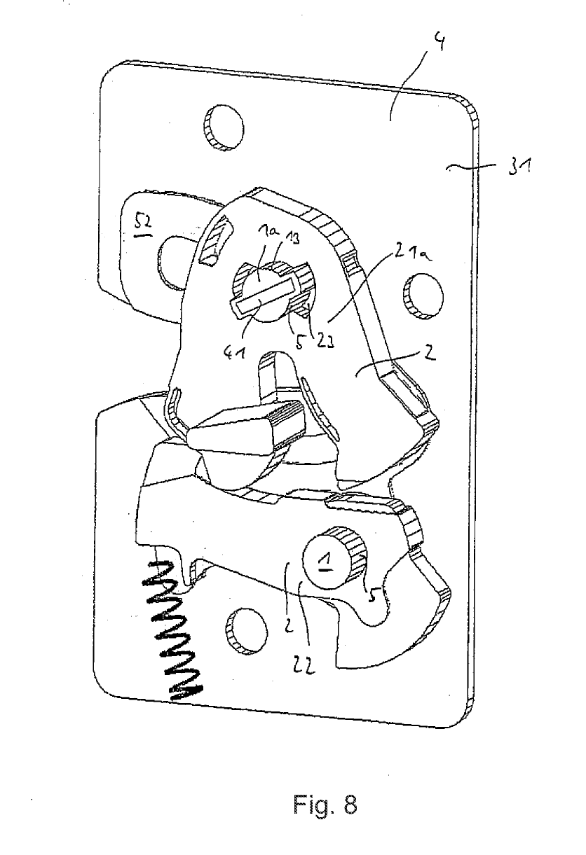

FIG. 8 shows a top view from the front onto a carrier plate 4 in which bearing pins 1, 1a are formed and locking pieces 2 accommodated thereon, in which the bearing pin la of the catch 21a is designed according to a type of the invention,

The extrusion coating 5 of the bearing pin 1a forms a smaller internal diameter and a larger external diameter. Accordingly, the catch 21a contains a mainly dovetail-shaped bearing seat opening 23, corresponding to the bearing pin 1a. This arrangement forms a stop for the catch preventing it from being turned around the bearing axis by more than a specified amount.

Because of this design, the clip-shaped form 41 can be very wide without the entire bearing seat opening 23 having to have the greater diameter 12 of the bearing pin 1a. The advantage of this is that in the main direction of the force transfer F, higher forces can be transferred onto the carrier plate by the clip-shaped form 41 and the plastic extrusion coating 5.

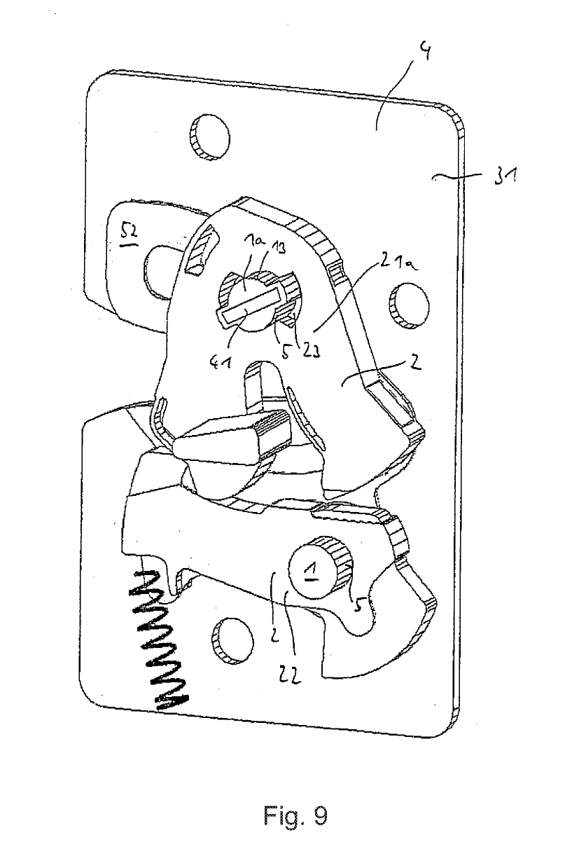

FIG. 9 shows details of the bearing pin la in the dovetail-shaped bearing seat opening 23.

The extrusion coating 5 of the bearing pin 1a forms a smaller internal diameter 11 and a larger external diameter 12, with the larger diameter 12 being provided in the main direction of the force transfer F from the catch 21a on the bearing pin 1a. The catch 21a contains, corresponding to the form of the bearing pin 1a, a mainly dovetail-shaped bearing seat opening 23, containing a corresponding smaller internal diameter 24 and a larger external diameter 25.

1-17. (canceled)

18. A method of producing a bearing pin for locking pieces of a motor vehicle door lock, in which the locking pieces are at least partially rotationally mounted on the bearing pin forming a bearing axis, comprising:
forming a clip-shaped form in essentially an axial direction of the bearing axis, from a metal carrier plate supporting at least one locking piece; and
forming the bearing pin by extrusion coating about the clip-shaped form, wherein the extrusion coating of the bearing pin is produced through the Outsert Method which further comprises:
spraying in a single production step, a plastic material directly about said clip-shaped form wherein at least one edge, opening or projection on the metal carrier plate anchors the sprayed plastic material around said clip-shaped form.

19. The method of producing a bearing pin for locking pieces according to claim 1, further comprising, in a single process step, forming the clip-shaped form by punching the clip-shaped form out of the carrier plate and moving the clip-shaped form in an upright direction in the axial direction of the bearing axis.

20. The method of producing a bearing pin for locking pieces according to claim 1, wherein the clip-shaped form is formed into a planar shape.

21. The method of producing a bearing pin for locking pieces according to claim 1, wherein the extrusion coating of the clip-shaped form forms a cylindrical bearing pin.

22. The method of producing a bearing pin for locking pieces according to claim 1, wherein the extrusion coating of the bearing pin forms a bearing pin having a smaller internal diameter and a larger external diameter, with the larger external diameter being provided in a direction of main force transfer from the locking pieces onto the bearing pin.

23. The method of producing a bearing pin for locking pieces according to claim 1, further comprising forming an essentially dovetail-shaped bearing seat opening in at least one of the locking pieces corresponding to the bearing pin, wherein the opening has a smaller internal diameter and a larger external diameter.

24. The method of producing a bearing pin for locking pieces according to claim 1, wherein a frame box is arranged to function as the carrier plate.

25. The method of producing a bearing pin for locking pieces according to claim 1, wherein the locking pieces comprise a catch and a pawl of the motor vehicle door lock.

26. The method of producing a bearing pin for locking pieces according to claim 1, wherein one of the locking pieces is mounted on the bearing pin.

27. The method of producing a bearing pin for locking pieces according to claim 1, further comprising applying a plastic extrusion coating to form at least one of a guiding groove, a guiding elevation and a stop for the locking pieces, at least partially contained within the carrier plate or a lock housing enclosing the locking pieces.

28. The method of producing a bearing pin for locking pieces according to claim 1, further comprising partially covering the locking pieces with a plastic extrusion coating produced using the Outsert Method.

29. The method of producing a bearing pin for locking pieces according to claim 1, further comprising covering, at least partially, an outer edge of the carrier plate or an edge of an opening or an edge of a punched-out section with a plastic extrusion coating produced using the Outsert Method.

30. The method of producing a bearing pin for locking pieces according to claim 1, further comprising covering, at least partially, an area between the locking pieces and at least one of the carrier plate, a frame box and a lock housing with a plastic extrusion coating produced using the Outsert Method.
